(19) United States
(12) Patent Application Publication
(10) Pub. No.: US 2010/0219069 A1
(43) Pub. Date: Sep. 2, 2010

(54) Gas Diffusion Layer and Method for the Production Thereof

(75) Inventors: Klaus-Dietmar Wagner, Heddesheim (DE); Achim Bock, Weinheim (DE); Karim Salama, Weinheim (DE); Achim Weller, Gorxheimertal (DE)

Correspondence Address: Pearl Cohen Zedek Latzer, LLP, 1500 Broadway, 12th Floor, New York, NY, 10036, US

(73) Assignee: Carl Freudenberg KG, Weinheim (DE)

(21) Appl. No.: 11/990,160

(22) PCT Filed: Aug. 9, 2006
(86) PCT No.: PCT/EP2006/007871

§ 371 Date: Feb. 7, 2008

(30) Foreign Application Priority Data
Sep. 9, 2005 (DE) 10 2005 043 203.4

(51) Int. Cl. C25B 13/08; B01D 53/22; C25B 13/00

(52) U.S. Cl. 204/296; 96/8; 204/295

(57) ABSTRACT

A gas diffusion layer having a layer (2) comprising fibers (1), whereby the fibers (1) are partially provided with a coating material (3), whereby the fibers (1) lie against each other at contact sites (4) and whereby the layer (2) has boundary surfaces (5) facing the surroundings—in terms of achieving the envisaged objective of ensuring an optimal electric conductivity—is characterized in that the fibers are freed of coating material (3) at the contact sites and/or at the boundary surfaces. Furthermore, a method is proposed for the production of a gas diffusion layer, said method comprising the step that the coating material (3) is selectively removed from the fibers (1) in certain areas.

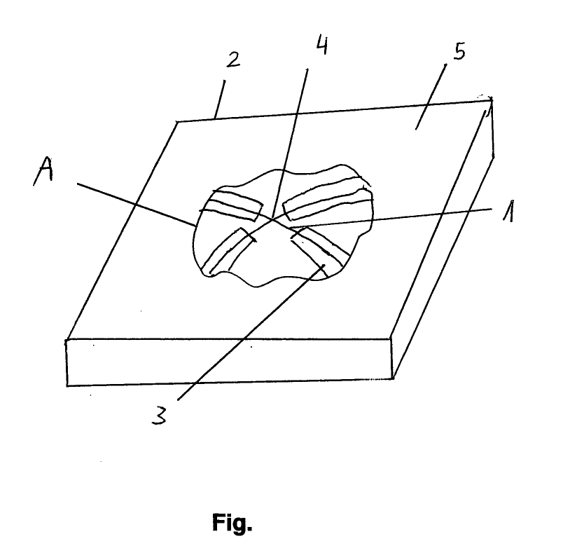

### FIELD OF THE INVENTION

The invention relates to gas diffusion layers having a layer comprising fibers, whereby the fibers are partially provided with a coating material, whereby the fibers lie against each other at contact sites and whereby the layer has boundary surfaces facing the surroundings. The invention also relates to methods for the production of a gas diffusion layer in which a layer comprising fibers is provided with coating material and in which the fibers are at least partially covered with coating material.

### DESCRIPTION OF RELATED ART

Such gas diffusion layers and methods are already known from the state of the art and are employed in fuel cells that convert chemical energy into electric energy. The electric resistance of a gas diffusion layer is of crucial importance for the efficiency of a fuel cell.

Gas diffusion layers are provided with coating materials for various reasons. These materials, however, exert a decisive influence on the electric conductivity behavior of a gas diffusion layer.

When it comes to this physical property, the gas diffusion layers known from the state of the art, which are mechanically bonded, such as, for example, nonwoven or woven fabrics, exhibit relatively high and poorly optimized resistance values after they have been coated according to the state of the art.

### SUMMARY OF THE INVENTION

Therefore, the invention is based on the objective of configuring and refining a gas diffusion layer of the above-mentioned type in such a way that an optimal electric conductivity behavior is present.

The present invention achieves the objective outlined above by means of the features of Patent Claim 1. According to this claim, a gas diffusion layer is characterized in that the fibers are freed of coating material at the contact sites and/or at the boundary surfaces.

According to the invention, first of all, it was recognized that concrete areas, namely, the boundary surfaces and contact sites of the fibers, have a decisive influence on the electric conductivity. In a second step, it was then recognized that the selective removal of coating material from specific areas of a gas diffusion layer changes the stability and the physical-chemical properties of the gas diffusion layer only to the absolutely necessary extent. Finally, it was recognized that the selective removal of coating material from specific areas allows certain resistance values to be reproduced. The removal of coating material from the boundary surfaces reduces the electric contact resistance to adjacent components in a fuel cell arrangement. Hence, a gas diffusion layer is being put forward that always exhibits optimal electric conductivity behavior.

Consequently, the above-mentioned objective has been achieved.

The objective is also achieved by means of the features of the alternative independent Patent Claim 2

In fact, if a gas diffusion layer in which the contact sites of the fibers are largely free of coating material is heated up to a temperature that is equal to or higher than the melting, softening or sintering temperature, then the coating material can flow back together again at the contact sites. As a result, the electric conductivity worsens significantly again and the electric resistance is markedly raised once.

The term electric resistance refers to the contact resistance through the layer. The latter can be arranged between suitable electrodes in order to measure the electric resistance. The heating up procedure normally causes the electric resistance to at least double in value. If a gas diffusion layer according to the invention has a given electric resistance at room temperature (T=20° C. [68° F.]) before the heating up procedure, then this electric resistance can be raised once only by heating the gas diffusion layer up to a temperature equal to or above the melting, softening or sintering temperature of the coating material. Hence, after the gas diffusion layer has been heated up once and cooled back down to room temperature, it exhibits a markedly higher electric resistance.

In a configuration with a particularly favorable design, the layer could be configured as a conductive textile fabric. This specific configuration allows problem-free processing of prefabricated semi-finished products. The use of a textile fabric ensures that the gas diffusion layer displays certain elastic properties and can be, for example, rolled or deformed.

The layer could comprise carbon fibers. Carbon stands out for its particularly favorable electric conductivity behavior. Carbon fibers also display high stiffness, stability and low density, as a result of which they are well-suited for the manufacture of lightweight and stable layers. Before this background, it is also conceivable to use carbon fiber paper or carbon nonwoven fabric, both of which ensure good access to the electrodes by the reagents that are found in a fuel cell.

The coating material could be configured as a hydrophobing agent. For instance, it is conceivable that, in the case of a hydrophobic configuration, reaction water that is formed in the fuel cell is prevented from clogging the pores of the gas diffusion layer, which would prevent the flow of gas.

It is likewise conceivable for the coating material to be configured as a hydrophilizing agent. As a result, the accumulation of water on the gas diffusion layer could be promoted, thus preventing its drying out, which would cause a deterioration of the proton conductivity.

Depending on the selection of the hydrophobic or hydrophilic properties of the gas diffusion layer, the gas or liquid flow through the gas diffusion layer—the gas and water management—can be optimized. In this context, it is even conceivable for the gas diffusion layer to be concurrently provided with a hydrophobing agent in some areas and with a hydrophilizing agent in other areas.

The coating material could function as a binder. This configuration makes it possible to create a chemical bonding of the fibers of the layer. Here, it is especially conceivable for the fibers to be joined to each other via coating material structures, whereby the intersections where the fibers lie against each other are free of coating material. The binder can contain additives such as carbon black, for purposes of raising the electric conductivity and/or to create hydrophilic or less hydrophobic centers.

The gas diffusion layer could be stabilized by a combination of thermal, chemical or mechanical bonding mechanisms. The combination of various bonding mechanisms allows the selective setting of several physical and chemical properties of the gas diffusion layer.

The coating material could comprise a proportion of 0% to 70% by volume. The elastic and mechanical properties of the layer can also be set entirely as a function of the selection of the percentage of coating material. Especially preferably, the proportion of coating material could comprise 5% to 20% by volume. Through the selection of this range, in spite of satisfactory hydrophobic properties, the gas diffusion layer exhibits a likewise satisfactory water retention capacity.

The coating material could comprise polytetrafluoroethylene. Polytetrafluoroethylene is particularly well-suited as a hydrophobing agent since it is readily commercially available and has been thoroughly researched in terms of its physical-chemical properties. Moreover, polytetrafluoroethylene can be easily dispersed in a liquid. In addition to polytetrafluoroethylene, it is also possible to use fluoropolymers such as, for example, fluorinated ethylene propylene (FEP) as well as copolymers of fluoropolymers, silanes or other hydrophobic materials that can be easily applied onto the gas diffusion layer. Fluoropolymers are hydrophobic materials that stand out for their high thermal and chemical stability.

A microporous coating could be associated with at least one boundary surface. This results in better bonding to a catalyst layer that can be applied onto the microporous coating of the gas diffusion layer or that can be provided on a proton-conductive membrane of a fuel cell. The microporous coating could be applied in such a way that, with a suitable selection of the raw material and proper process management, the coating material concentration in the area of the contact sites is not affected.

The gas diffusion layer could undergo a plasma treatment. Such a plasma treatment can bring about a selective bonding of ions or molecules to existing structures. This has an influence on the permeation properties of the gas diffusion layer with respect to fluids. Due to the plasma treatment, in addition to the hydrophobic and hydrophilic areas created by the coating material, other such areas can also be created.

The above-mentioned objective is also achieved by a method having the features of Patent Claim 12. According to this claim, a method for the production of a gas diffusion layer is characterized in that the coating material is selectively removed from the fibers in certain areas.

The above-mentioned objective is also achieved by a method having the features of Patent Claim 13.

In order to avoid repetitions, when it comes to the aspect of the inventive step, reference is hereby made to the elaborations pertaining to the gas diffusion layer as such.

The coating material could be removed by the application of pressure. In this context, it is conceivable for the gas diffusion layer to be passed through an arrangement that applies a defined pressure onto the gas diffusion layer in such a way that the coating material between two adjacent fibers is squeezed out. In particular, the compressive force exerted on the layer could be selected as a function of the conductivity desired for the gas diffusion layer. By means of this method, a gas diffusion layer with a prescribed conductivity can be reproducibly created.

Before this background, it is likewise conceivable for the coating material to comprise one or more additives that cause the coating material not to adhere to the boundary surfaces of the gas diffusion layer facing the atmosphere. Here, it is conceivable for the coating material to preferably penetrate the bulk phase of the layer.

The coating material could be removed before, during or after a tempering process.

The tempering process causes a thermoplastic coating material to melt uniformly so as to form a homogenous layer; this is also known as sintering. A sintering process is normally carried out at the sintering temperature of the coating material.

Removal during the sintering process translates into a particularly fast manufacturing process using thermoplastic coating materials, since these have sufficient fluidity in their molten state. This fluidity allows the coating material to be removed from between the contact sites.

Removal after the sintering process in a subsequent process step allows an optimization of the sintering process, whereby the coating material concentration between the contact sites can be ignored.

When a cross-linking coating material is used, the tempering process serves to ensure a homogeneous and sufficiently complete cross-linking reaction. Removal before the tempering process ensures that the contact sites are almost completely free of coating material before the cross-linking reaction.

The layer could be finished with coating material either in a moist or dry state. The dry finish has the advantage that drying processes are not needed prior to the sintering process. The moist finish allows a complete wetting of the fibers with coating material, so that an almost complete sheathing of the fibers can be ensured. This means that a mechanically highly stable and homogeneously structured gas diffusion layer can be created.

There are several possibilities to configure and refine the teaching of the present invention in an advantageous manner. Towards this end, reference is hereby made, on the one hand, to the subordinate claims and, on the other hand, to the explanation below of a preferred embodiment of the invention making reference to the drawing. Generally preferred configurations and refinements of the teaching will also be explained in conjunction with the explanation of the preferred embodiment of the invention with reference to the drawing.

### BRIEF DESCRIPTION OF THE DRAWING

The following is shown in the single

FIGURE: a schematic view of a gas diffusion layer according to the invention.

### WAYS TO EXECUTE THE INVENTION

The single FIGURE shows a schematic view of a gas diffusion layer having a flat layer 2. Section A shows an enlarged view of the layer 2. The layer 2 comprises fibers 1, whereby the fibers 1 are partially provided with a coating material 3, whereby the fibers 1 lie against each other at contact sites 4 and whereby the layer 2 has boundary surfaces 5 facing the surroundings. The fibers 1 are freed of coating material 3 at the contact sites 4 and/or at the boundary surfaces 5.

The layer 2 is configured as a conductive textile fabric and comprises carbon fibers. The coating material 3 is configured as a hydrophobing agent. Polytetrafluoroethylene is used as the coating material 3.

Regarding other advantageous configurations and refinements of the teaching according to the invention, reference is hereby made, on the one hand, to the general part of the description and, on the other hand, to the accompanying patent claims.

In conclusion, special mention should be made of the fact that the purely randomly chosen embodiment above serves merely to elucidate the teaching according to the invention but that this does not restrict the teaching to this embodiment.

1-16. (canceled)

17. A gas diffusion layer having a layer comprising:
fibers, whereby the fibers are partially provided with a coating material, whereby the fibers lie against each other at contact sites and whereby the layer has boundary surfaces facing the surroundings, wherein the fibers are freed of coating material at the contact sites and/or at the boundary surfaces.

18. The gas diffusion layer having a layer comprising:
fibers, whereby the fibers are partially provided with a coating material, whereby the fibers lie against each other at contact sites and whereby the layer has boundary surfaces facing the surroundings, wherein an electric resistance at room temperature that can be raised by heating up the gas diffusion layer once to a temperature that is equal to or higher than the melting temperature of the coating material.

19. The gas diffusion layer as recited in claim 17, wherein the layer is configured as a conductive textile fabric.

20. The gas diffusion layer as recited in claim 17, wherein the layer comprises carbon fibers.

21. The gas diffusion layer as recited in claim 17, wherein the coating material comprises a hydrophobing agent.

22. The gas diffusion layer as recited in claim 17, wherein the coating material comprises a hydrophilizing agent.

23. The gas diffusion layer as recited in claim 17, wherein the coating material functions as a binder.

24. The gas diffusion layer as recited in claim 17, wherein a proportion of coating material of 0% to 70% by volume.

25. The gas diffusion layer as recited in claim 17, wherein the material comprises polytetrafluoroethylene, fluoropolymers or silanes.

26. The gas diffusion layer as recited in claim 17, wherein a microporous coating is associated with at least one boundary surface.

27. The gas diffusion layer as recited in claim 17, having undergone a plasma treatment.

28. A method for the production of a gas diffusion layer as recited in claim 17, wherein a layer comprising fibers is provided with a coating material and in which the fibers are at least partially covered with coating material, wherein the coating material is selectively removed from the fibers in certain areas.

29. A method for the production of a gas diffusion layer as recited in claim 17, wherein a layer comprising fibers is provided with a coating material and in which the fibers are at least partially covered with coating material, wherein the electric resistance of the gas diffusion layer is raised once by heating it up to a temperature equal to or above the melting temperature of the coating material.

30. The method as recited in claim 28, wherein the coating material is removed by the application of pressure.

31. The method as recited in claim 28, wherein the coating material is removed before, during or after a tempering process.

32. The method as recited in claim 28, wherein the layer is finished with coating material either in a moist or dry state.
